(19) United States
(12) Patent Application Publication
(10) Pub. No.: US 2008/0278330 A1
(43) Pub. Date: Nov. 13, 2008

(54) Protective Frame For Identification Tags

(75) Inventor: Peter M. Hass, Orinda, CA (US)

Correspondence Address: HOLLAND & KNIGHT LLP, 633 WEST FIFTH STREET, TWENTY-FIRST FLOOR, LOS ANGELES, CA, 90071-2040, US

(73) Assignee: Petsport USA, Inc., Pittsburg, CA (US)

(21) Appl. No.: 11/746,498

(22) Filed: May 9, 2007

(51) Int. Cl. G08B 13/14

(52) U.S. Cl. 340/572.8

(57) ABSTRACT

A frame for receiving therein and extending about a planar identification tag of the type having an apertured tab projecting therefrom for securing the tag to a pet collar or personal item. The frame comprises a backing, a flange projecting from and circumscribing a perimeter portion of the backing and a pair of elongated slots formed in opposed portions of the flange. One of the slots is sized so as to allow an identification tag to be inserted therethrough and the other of the slots is sized to allow a projecting apertured tab on the tag to be inserted therethrough and project from the frame such that securing a fastener member through the aperture in the projecting tab secures the tag within the frame.

### BACKGROUND OF THE INVENTION

While personalized luggage tags and pet identified tags have been in widespread use for years, recently, computerized engraving equipment has been developed that enables people to engrave their own tags. Such equipment is available, for example, by the Hillman Group located in Cincinnati, Ohio and utilizes a computer-driven engraver and an easy to use video touch screen. Such equipment is located in a variety of retail outlets and enables the user to select their tag from a limited number of blank tag styles and sizes and engrave the face of the blank with their own or their pet's identification information. In each case, the engraving is on a single side of a flat metal blank of a selected configuration (e.g. heart-shaped, rectangular or military style round or bone-shaped). Because of the growing popularity of these self made computer generated tags and their plain appearance, it would be highly desirable to provide an inexpensive frame for the tags which could both enhance their appearance and provide protection for the engraved surface. Such a frame should be of simple construction, economical to manufacture and readily attachable to the tag. The present invention provides such a frame.

### SUMMARY OF THE INVENTION

Briefly, the present invention comprises a frame that fits about a perimeter portion of a pet or personal identification tag of the type having a protruding apertured tab used to secure the tag to an item to be identified such as the collar of a pet or a piece of luggage. The frame of the present invention fits about the perimeter portion of the tag and defines a first elongated slot therein through which the tag can be inserted into the frame and a second and opposed slot of a shorter length through which the tag tab projects upon the tag being fully inserted within the frame. By then inserting a conventional fastener, such as a split ring, through the aperture in the tab protruding from the frame and about a portion of the item to which the tag is to be secured, the tag is both affixed to the item and retained within the frame without the need for further attachment members. Resilient stoppers can be provided in the frame about portions of the first elongated slot to inhibit any relative movement between the tag and the attached frame.

In an alternate embodiment of the invention adapted for use with apertured identification tags that lack projecting tabs such as the rectangular or military style frequently used on luggage, the frame defines an elongated slot through which the tag can be inserted such that the frame surrounds the tag and an aperture extending through the frame perpendicular to the slot and positioned so as to be axially aligned with the aperture in the tag upon the tag being inserted into the frame through the elongated slot. By then inserting a conventional fastener, such as a split ring, through the aligned apertures in the frame and tag and about a portion of the item to which the tag is to be secured, the tag is both affixed to the item and retained within the frame without the need for further attachment members. Resilient stoppers can again be employed in the frame slot to prevent relative movement of the tag and attached frame.

### BRIEF DESCRIPTION OF THE DRAWINGS

FIG. 1 is a perspective view of a protective frame of the present invention.

FIG. 2 is an exploded frontal view of a frame of the present invention and identification tag for insertion within the frame.

FIG. 3 is a frontal view of a pet identification tag disposed within a frame of the present invention and secured therein with a split ring fastener.

FIG. 4 is a bottom view of the frame of the present invention.

FIG. 5 is a partial perspective view of the frame of the present invention illustrating one of the tag stoppers.

FIG. 6 is a partial side view of the present invention illustrating a pair of stoppers disposed within the tag insertion slot.

FIGS. 7A and 7B are frontal views of examples of alternate shapes of the embodiment of the present invention illustrated in FIGS. 1-6.

FIG. 8 is a frontal view of a second embodiment of a protective frame of the present invention and a mating identification tag.

FIG. 9 is a bottom plan view of the second embodiment of the present invention illustrated in FIG. 8.

FIG. 10 is a top plan view of the second embodiment of the present invention illustrated in FIG. 8.

### DETAILED DESCRIPTION OF THE PREFERRED EMBODIMENTS

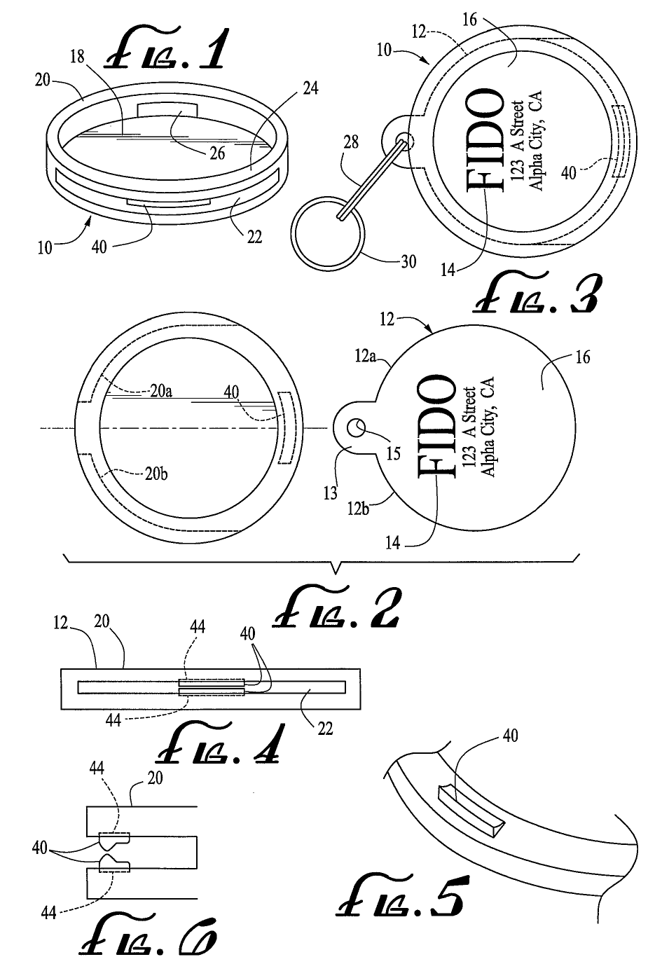

Referring now in detail to the drawings, the frame 10 of the present invention is adapted to receive and extend about the perimeter portion of a personal or pet identification tag 12 such that the printed identification indicia 14 on the front surface 16 of the tag is readily readable through frame 10. In a first embodiment of the present invention illustrated in FIGS. 1-4, frame 10 comprises a generally planar backing 18 and an endless flange 20 projecting outwardly from backing 18 and extending about a perimeter portion thereof. The flange 20 defines a first elongated opening or slot 22 in a lower portion 24 thereof and a second shorter opening or slot 26 in an upper portion 28 thereof as seen in FIG. 1. The frame 10 is provided with a planar backing as the computer generated identification tags, like most conventional identification tags, have printed information only on one side thereof. If desired for use on identification tags having printed information on both sides, or for any other reasons, the planar backing 18 could be eliminated and the frame could be of an annular configuration.

The frame 10 is particularly configured and sized to receive therein identification tag 12 such that tag 12 can be inserted into the frame through elongated slot 22 with upper arcuate perimeter portions 12a and b of tag 12 abutting interior arcuate surfaces 20a and 20b of flange 20 and the projecting apertured tab 13 on tag 12 extending through the upper slot 26 in frame 20 as shown in FIG. 3. So positioned, the insertion of a split ring 28 or other conventional fastener through the aperture 15 in the tag tab 13 locks the tag within the frame and enables the framed identification tag 12 to be readily attached, for example, to the collar of a pet via ring 30 as shown in FIG. 3 or to a piece of luggage or other item. So attached, the frame completely surrounds the tag 12, enhancing the attractiveness of the tag and providing a protective surround for the tag. If desired, the ornamental appearance of frame 10 could be enhanced by the inclusion of rhinestones or other decorative elements thereon and/or the backside of the planar backing 18 also could be provided with rhinestones or other ornamental features.

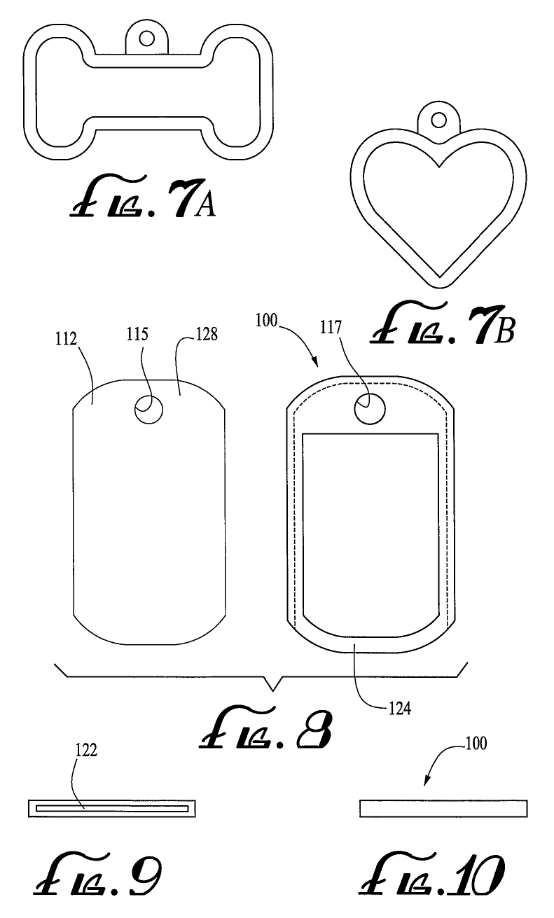

To prevent any relative movement between the frame 10 and tag 12 and consequential rattling or jiggling, a pair of flexible and resilient rubber stoppers 40 (see FIGS. 5 and 6) can be provided in the bifurcated portions of frame 10 about elongated slot 22. The flexibility and resiliency in these stoppers enable the tag to be inserted therebetween, deforming the stoppers, and into the interior of the frame whereupon the opposed deformed stoppers continue to engage and bear against lower portions of the tag so as to inhibit relative movement therebetween. In the embodiments illustrated in the drawings, the stoppers 40 define projecting engagement portions 40a and are positioned in opposed recessed areas 44 in the lower portion of the frame and secured by a suitable adhesive. Other stopper configurations and attachment means could be employed.

From the above description, it is apparent that the frame 10 could be configured and sized to cooperate with a wide variety of configurations and sizes of the identification tags to provide the above-described fitment. This cooperation is facilitated by the fact that the sizes and shapes of the identification tags produced by the earlier-described computerized systems are relatively few and are standardized. Examples of alternate shapes of tags and frames 10 made in accordance with the present invention are illustrated in FIGS. 7A and 7B.

An alternate embodiment of the present invention is illustrated in FIGS. 8-10. In this alternate embodiment, the frame 100 is adapted for use with identification tags that do not include projecting apertured tabs. One such configuration is the rectangular or military-style identification tag 112 illustrated in FIG. 8. As seen therein, the tag 112 both has a different shape than tag 12 and has an aperture 115 provided in an upper end portion 128 of the tag 112. Frame 100 is correspondingly configured to receive tag 112 and, like frame 10, is provided with an elongated slot 122 in a lower portion 124 of the frame. Unlike frame 10, the upper end of frame 110 is closed and the upper portion 128 of frame 110 is enlarged to accommodate an aperture of 117 extending therethrough perpendicular to the slot 122 in the lower portion of the frame. Aperture 117 is positioned so as to be axially aligned with aperture 115 in tag 112 upon tag 112 being inserted into the frame 110 through the elongated slot 122 in the manner described above with respect to the prior embodiment. Alternatively, the elongated slot 122 could be provided in the upper end of the upper body portion 128 of frame 110 as opposed to being disposed in the lower portion 124 thereof, and the tag 112 inserted downwardly therethrough to provide the desired aperture alignment. With tag 112 disposed within the frame 110 and the apertures 115 and 117 in the tag and frame aligned, a split ring (not shown) or other conventional securement devices can be inserted through the aligned apertures securing the frame about the tag as in the prior embodiment. If desired, stoppers (not shown) similar to stoppers 40 in frame 10 could be disposed in frame 100 about slot 122 to prevent any relative motion between the frame and tag.

Various changes and modifications may be made in carrying out the present invention without departing from the spirit and scope thereof. As these changes and modifications are within the purview of the appended claims, they are to be considered as part of the present invention.

I claim:

1. A frame adapted to receive therein and extend about at least a perimeter portion of a planar identification tag of the type having a projecting tab and an aperture in the tab for use in securing the tag to a pet collar or personal item, said frame comprising:
a backing;
a flange projecting from and circumscribing a perimeter portion of said backing; and
a pair of elongated slots formed in opposed portions of said flange, a first of said slots being sized so as to allow a planar identification tag to be inserted therethrough into said frame and the second of said slots being shorter in length than said first slot and sized so as to allow an apertured tab on a planar identification tag to be inserted therethrough and project from said frame upon the tag being inserted into said frame through said first slot whereby upon inserting a fastener member through the apertured tab projecting through said second slot, an identification tag is secured within said frame.

2. The frame of claim 1 including at least one resilient engagement member carried by said frame and projecting into said first slot whereby upon an identification tag being inserted into said frame through said first slot, said engagement member will abut and bear against a portion of the tag and inhibit relative movement between said frame and the tag.

3. The frame of claim 1 including a pair of deformable resilient engagement members carried by said frame on opposed sides of said first slot so as to project into said first slot such that upon an identification tag being inserted into said frame through said first slot, said engagement members will deform and bear against portions of the tag and inhibit relative movement between said frame and the tag.

4. A frame adapted to receive therein and extend about at least a perimeter portion of a planar identification tag of the type having a projecting tab and an aperture in the tab for use in securing the tag to a pet collar or personal item, said frame comprising:
a flange projecting from and circumscribing a perimeter portion of said backing; and
a pair of elongated slots formed in opposed portions of said flange, a first of said slots being sized so as to allow a planar identification tag to be inserted therethrough into said frame and the second of said slots being shorter in length than said first slot and sized so as to allow an apertured tab on a planar identification tag to be inserted therethrough and project from said frame upon the tag being inserted into said frame through said first slot whereby upon inserting a fastener member through the apertured tab projecting through said second slot, an identification tag is secured within said frame.

5. The frame of claim 4 including at least one resilient engagement member carried by said frame and projecting into said first slot whereby upon an identification tag being inserted into said frame through said first slot, said engagement member will abut and bear against a portion of the tag and inhibit relative movement between said frame and the tag.

6. The frame of claim 4 including a pair of deformable resilient engagement members carried by said frame on opposed sides of said first slot so as to project into said first slot such that upon an identification tag being inserted into said frame through said first slot, said engagement members will deform and bear against portions of the tag and inhibit relative movement between said frame and the tag.

7. A frame adapted to receive therein and extend about at least a perimeter portion of a planar identification tag of the type having an aperture therein for use in securing the tag to a pet collar or personal item, said frame comprising:
a backing;
a flange projecting from and circumscribing a perimeter portion of said backing;
an elongated slot formed in an end portion of said frame sized so as to allow a planar identification tag to be inserted therethrough; and
an aperture extending through said frame perpendicular to said slot and positioned therein for axial alignment with an aperture in an identification tag upon the tab being inserted through said slot in said frame whereby upon inserting a fastener member through said aperture in said frame and the aligned aperture in the tag, said tag is secured within said frame.

8. The frame of claim 7 wherein said slot and said aperture are in opposed portions of said frame.

9. The frame of claim 7 including at least one resilient engagement member carried by said frame and projecting into said slot whereby upon an identification tag being inserted into said frame through said slot, said engagement member will abut and bear against a portion of the tag and inhibit relative movement between said frame and the tag.

10. The frame of claim 8 including at least one resilient engagement member carried by said frame and projecting into said slot whereby upon an identification tag being inserted into said frame through said slot, said engagement member will abut and bear against a portion of the tag and inhibit relative movement between said frame and the tag.

11. The frame of claim 7 including a pair of deformable resilient engagement members carried by said frame on opposed sides of said first slot so as to project into said first slot such that upon an identification tag being inserted into said frame through said first slot, said engagement members will deform and bear against portions of the tag and inhibit relative movement between said frame and the tag.

12. The frame of claim 8 including a pair of deformable resilient engagement members carried by said frame on opposed sides of said first slot so as to project into said first slot such that upon an identification tag being inserted into said frame through said first slot, said engagement members will deform and bear against portions of the tag and inhibit relative movement between said frame and the tag.

13. A frame adapted to receive therein and extend about at least a perimeter portion of a planar identification tag of the type having an aperture therein for use in securing the tag to a pet collar or personal item, said frame comprising:
a flange projecting from and circumscribing a perimeter portion of said backing;
an elongated slot formed in an end portion of said frame sized so as to allow a planar identification tag to be inserted therethrough; and an aperture extending through said frame perpendicular to said slot and positioned therein for axial alignment with an aperture in an identification tag upon the tab being inserted through said slot in said frame whereby upon inserting a fastener member through said aperture in said frame and the aligned aperture in the tag, said tag is secured within said frame.

14. The frame of claim 13 wherein said slot and said aperture are in opposed portions of said frame.

15. The frame of claim 13 including at least one resilient engagement member carried by said frame and projecting into said first slot whereby upon inserting an identification tag being inserted into said frame through said first slot, said engagement member will abut and bear against a portion of the tag and inhibit relative movement between said frame and the tag.

16. The frame of claim 14 including at least one resilient engagement member carried by said frame and projecting into said first slot whereby upon inserting an identification tag being inserted into said frame through said first slot, said engagement member will abut and bear against a portion of the tag and inhibit relative movement between said frame and the tag.
